(19) United States
(12) Patent Application Publication
(10) Pub. No.: US 2019/0244314 A1
(43) Pub. Date: Aug. 8, 2019

(54) SYSTEMS AND METHODS FOR MANAGING CONTENT ON AN ECOSYSTEM

(71) Applicant: NextJuris Inc., Atlanta, GA (US)

(72) Inventors: Nathan S. Huynh, Roswell, GA (US); Minh N. Nguyen, Brookhaven, GA (US)

(73) Assignee: NextJuris Inc., Atlanta, GA (US)

(21) Appl. No.: 16/271,766

(22) Filed: Feb. 8, 2019

Related U.S. Application Data
(60) Provisional application No. 62/628,259, filed on Feb. 8, 2018.

(51) Int. Cl. G06Q 50/20; G06F 16/25

(52) U.S. Cl. CPC G06Q 50/2057; G06F 16/25

(57) ABSTRACT

Systems and methods for a content exchange ecosystem are provided. A representative content exchange ecosystem includes a course manager, a content provider database, an approved provider database, and a content importer database. The course manager manages courses from and to various entities that participate on the content exchange ecosystem. The content provider database includes course catalogs of content providers on the content exchange ecosystem, wherein the content provider database provides educational content to the course manager for approval and/or importing. The approved provider database includes course catalogs of approved providers, wherein the approved providers receive the educational content from the content providers, and approve or reject the educational content, wherein the course manager receives the approved educational content. The content importer database includes course catalogs of content importers, wherein the content importers receive the educational content from the course manager and imports the educational content into course catalogs associated with the content importers.

### CROSS REFERENCE TO RELATED APPLICATIONS

This application is a nonprovisional patent application of copending U.S. provisional application entitled, “Course Exchange Ecosystem,” having Ser. No. No. 62/628,259, filed on Feb. 8, 2018, which is entirely incorporated herein by reference.

### TECHNICAL FIELD

The present disclosure is generally related to content management platform and, more particularly, is related to systems and methods for managing content from and to various entities that participate on a content exchange ecosystem.

### BACKGROUND

In the legal profession, lawyers in most jurisdictions are responsible to complete mandatory continuing legal education (MCLE) courses to maintain their licenses to practice law. MCLE rules vary by jurisdictions. In general, a lawyer in an MCLE jurisdiction is responsible to complete a certain number of credit hours of MCLE courses over a compliance period.

In many jurisdictions, lawyers can complete all or part of their MCLE requirements by taking approved online courses. Because each jurisdiction has its own rules and regulations governing MCLE, courses that are approved for MCLE credits in one jurisdiction are not generally automatically approved in another jurisdiction. The complex and disjointed sets of MCLE rules across the various jurisdictions, combined with the high cost to produce MCLE courses, creates waste and inefficiency in MCLE course distribution. Many courses created for one jurisdiction are equally relevant in another jurisdiction (e.g., courses cover federal law issues).

Many jurisdictions allow organizations that have MCLE programs to become approved providers or sponsors) of MCLE courses. An approved provider is given the authority (from the MCLE regulating body in the jurisdiction) to offer and grant credit to all or some forms of permissible MCLE activities without first submitting separate applications requesting prior approval for each program offered. An approved provider can, therefore, certify and approve courses for MCLE credits within their approved jurisdiction without the need to go through the lengthy (and often expensive) process of having to submit each program for approval by the MCLE regulating body within their jurisdiction. Again, each jurisdiction has its own sets of rules governing who can become an approved provider. However, in general, an approve provider must have an active MCLE program and have had a certain number of educational activities approved for MCLE credits over a given period (e.g., four approved courses by the State Bar over the prior two years).

Unfortunately, most organizations with MCLE programs are only approved providers within their relevant jurisdictions. For example, a local bar association in. California typically only serves their members in California, and it can likely only seek an approved provider status in California. Courses offered by this local bar association, therefore, cannot generally be taken for credit outside of California (except for certain reciprocity and self-study rules). It can also be very expensive and time consuming to seek approved provider statuses in multiple jurisdictions. The disjointed sets of MCLE rules leads to waste and inefficiency because an approved provider that offer MCLE courses in ogre jurisdiction are not able to offer the same courses in jurisdictions in which the provider does not have approval statuses (without the need to seek individual program approval from the relevant MCLE regulating body). This greatly reduces the value of MCLE courses since they are not easily redistributable across jurisdictions, even though the course content can be equally relevant across jurisdictions.

Many bar associations would like to offer MCLE courses to their members to assist their members in meeting MCLE requirements. However, in most cases, only the larger bar associations have the resources to put MCLE programs together. MCLE courses can be expensive to produce, and an online learning management platform to deliver online courses can also be expensive. In addition, a smaller bar association generally does not have an MCLE program manager to coordinate a robust MCLE program with a sizeable course catalog and current course topics to keep the program engaging to members.

Desirable in the art is a content exchange ecosystem that would improve upon the content exchange ecosystem.

### SUMMARY

Systems and methods for a content exchange ecosystem are provided. A representative content exchange ecosystem includes a course manager, a content provider database, an approved provider database, and a content importer database. The course ager manages courses from and to various entities that participate on the content exchange ecosystem. The content provider database includes course catalogs of content providers on the content exchange ecosystem, wherein the content provider database provides educational content to the course manager for approval and/or importing. The approved provider database includes course catalogs of approved providers, wherein the approved providers receive the educational content from the content providers, and approve or reject the educational content, wherein the course manager receives the approved educational content. The content importer database includes course catalogs of content importers, wherein the content importers receive the educational content from the course manager and imports the educational content into course catalogs associated with the content importers.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 shows an overview of a content exchange ecosystem that includes a content distribution platform to facilitate and promote the sharing and distribution of content in accordance with an embodiment of the invention;

FIG. 2 illustrates courses imported by Content Importers in according with an embodiment of the invention;

FIG. 3 illustrates the flow of courses in accordance with an embodiment of the invention;

FIG. 4 shows an example ala user interface that assists the Approved Provider to review and approve courses for credits in GA in accordance with an embodiment of the invention;

FIG. 5 shows a content exchange ecosystem that includes a content management platform with Content Providers sharing and distributing courses on the Content Exchange in accordance with an embodiment of the invention;

FIG. 6 shows an example of Course Catalog for Content Importer in accordance with an embodiment of the invention;

FIG. 7 shows a Content Management Platform that includes Approved Providers; and

FIG. 8 is a block diagram illustrating an exemplary architecture for a generic computer that is similar to the architecture of the computing device, local server and central server, such as that shown in FIG. 1.

### DETAILED DESCRIPTION

Exemplary systems are first discussed with reference to the figures. Although these systems are described it detail, they are provided for purposes of illustration only and various modifications are feasible. After the exemplary systems are described, examples of flow diagrams of the systems are provided to explain the manner in which various entities can manage content on a content exchange ecosystem.

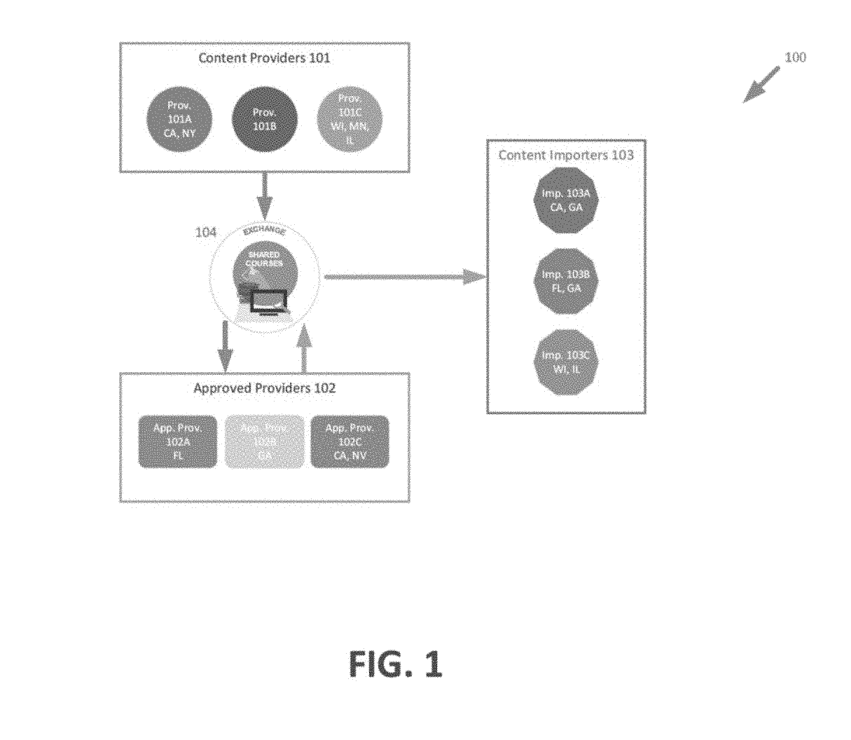

FIG. 1 shows an overview of a content exchange ecosystem that includes a content distribution platform to facilitate and promote the sharing and distribution of content, in accordance with an embodiment of the invention. In FIG. 1, Content Providers 101 possess (or control, own, created, or are the license holder of) content that they wish to distribute to Content Importers 103 and stores the content in a content provider database (not shown). As used herein, a content can be any courses, instructional videos, publications (print or otherwise), activities, educational programs, instructor information, reviews, or other similar learning content that can be certified or approved for credits. Credit as used herein refers to any form of certifications, distinction, honor or credit (including MCLE and other continuing education credits) associated with the content. Generally, credits are issued or awarded for taking and/or completing the content.

As shown in FIG. 1, some Content Providers 101 can approve content for credits in certain jurisdictions while others cannot. For example, Content Provider 101A can approve content for credits in California and New York, and Content Provider 101C can approve content for credits in Wisconsin, Minnesota and Illinois. Content Provider 101B, however, does not have the ability to approve its content for credits in any jurisdiction. A jurisdiction refers to any territory, state, municipality, country, area, field or other boundary over which authority is exercised with respect to the ability to certify and approve content for credits.

In one embodiment, Content Providers 101 can use the Content Exchange 104 to share or distribute its content with Content Importers 103. Approved Providers 102 take content from the Content Exchange 104 and approve the content for credits in their respective jurisdictions. The Approved Providers 102 stores its content in an approved provider database (not shown). Approved Providers 102 have approved provider statuses in their respective jurisdictions. For example, Approved Provider 102A is an approved provider in Florida. Approved Provider 102B is an approved provider in Georgia, and Approved Provider 102C is an approved provider in California and Nevada. As discussed above, an approved provider (or sponsor) has the authority to offer and grant credit to all or some forms of content within a jurisdiction. An approved provider can have approved provider statuses in multiple jurisdictions, as is the case with Approved Provider 102C in FIG. 1.

Content Importer 103A would like to import content from the Content Exchange 104 that are approved for credits in California (CA) and Georgia (GA). However, only Content Provider 101A provides content approved for credits in CA, and none of the Content Providers 101 have content approved for credits in GA. In this case, the Con Lent Exchange 104 routes all or some of the content from Content Providers 101 to Approved Providers 102. Approved Provider 102B can approve content for credits in GA, and Approved Provider 102C can approve content for credits in CA. Approved Providers 102B and 102C can review and approve all or some of the content from Content Providers 101 for credits in CA and GA. The approved content can be routed and stored at a content importer database (not shown) of the Content Importer 103A, and Content Importer 103A can have content originating from Content Providers 101, but with Credits approved for both CA and GA. In another embodiment, content from Content Provider 101A that is approved for credits in CA can be routed directly to Content Importer 103A without the need of the content being recertified for CA credits by Approved Content Provider 102C.

Note that the same content can be approved for credits from multiple parties. For example, in FIG. 1, a course from Content Provider 101A can be approved for CA credits by Content Provider 101A or Approved Provider 102C, and the same course can, be approved for 1) GA credits by Approved Provider 102B, 2) Florida (FL) credits by Approved Provider 102A, 3) Nevada (NV) credits by Approved Provider 102C, and 4) New York (NY) credits by Content Provider 101A. Therefore, the same content can lave multiple sources of credit approvals. The sources of credits for each content are tracked by the content exchange ecosystem 100. Even within the same jurisdiction, the source of credit approval can originate from different sources. For example, a course from Content Provider 101A can have credit approval for CA by Content Provider 101A or Approved Provider 102C.

Importer 1038 would like to import content that are approved for credits in FL and GA. Similarly, Approved Providers 102A and 102B can approve all or some of the content from Content Providers 101 for FL and GA credits, respectively.

Note that content from Provider 101A can be already approved for credits in California. In this case, the California approved content can be routed directed to Importer 103B, and Approved Provider 102C would only need to approve content from Content Providers 101 that have not yet been approved in California. In another embodiment, content from Content Provider 101A is routed to Approved Provider 102C to be recertified or reapproved for California, and Content Importers 104 would get all of their imported courses approved through Approved Providers 102. A combination of the two approaches can also be used, where some approved content for a jurisdiction comes directly from Content Providers 101, and other approved content for the same jurisdiction is routed from Approved Providers 102.

Content Importer 103C would like content that are approved in Wisconsin (WI) and Illinois (IL). Note that in FIG. 1, there are no Approved Providers 102 for WI or IL. In this case, approved content for WI and IL can be imported directly from Content Provider 101C in the case Where Content Provider 101C has content that is approved for credits in WI or IL. In this scenario, Content Importer 103C would not be able to get content that is approved in WI or IL from Content Providers 101A or 101B.

For simplicity, FIG. 1 illustrates Content Providers 101 and Approved Providers 102 as separate entities. However, in practice, Content Providers 101 can also serve as Approved Providers 102. For example, if Content Provider 101A has approved provider status in California and New York Content Provider 101A can also serve for Approved Providers 102 for either or both of those jurisdictions.

Similarly, Content Providers 101 can also be Content Importers 103. For example, Content Provider 101A can also be a content importer of content originating from Content Providers 101B and 101C, and vice versa. Moreover, Content Importers 104 can likewise play the roles of content providers and/or approved providers for certain content.

FIG. 1 shows that all content flows through the Content Exchange 104. The Content Exchange 104 contains logic to route content to the appropriate actors. Some content may require actions by the Content Providers 101, Approved Providers 102 and/or Content Importers 103 to be routed onto the Content Exchange 104. Other content can be automatically routed by the Content Exchange 104 without any action required from the Content Providers 101, Approved Providers 102 and/or Content Importers 103. Such automatic routing can follow default or prescribed rules.

Also, for simplicity, FIG. 1 only shows three Content Providers 100, three Approved Providers 102 and three Content Importers 103. However, in practice, there can be any number of Content Providers 101, Approved Providers 102, and Content Importers 103. There can also be multiple Approved Providers 102 covering one jurisdiction. In the case of multiple Approved Providers 102 for a particular jurisdiction, the Content Exchange 104 can route content for approval in the jurisdiction to the multiple Approved Providers 102 for that jurisdiction. In one embodiment, such content is routed to all the multiple Approved Providers 102, and each of the multiple Approved Providers 102 can approve any of the content for credits in that jurisdiction. Once a content is approved, it is rerouted hack to the Content Exchange 104 for importing by Content Importers 103. It can also be routed automatically to the Content Importers 103, depending on the rules applied. Other routing methods can also be used. For example, routing can be done to optimize workflow so that content get approved more quickly and efficiently.

An Approved Provider 102 does not have to approve all content for credits. An Approved Provider 102 can reject any content by not approving it for credits. However, rejected content from one Approved Provider 102 in a jurisdiction can be approved for credits by another Approved Provider 102 in the same jurisdiction.

Similarly, there can be multiple Content Providers 101 with content approved in a jurisdiction, and there can be multiple Content Importers 103 that wish to import content from the same jurisdictions.

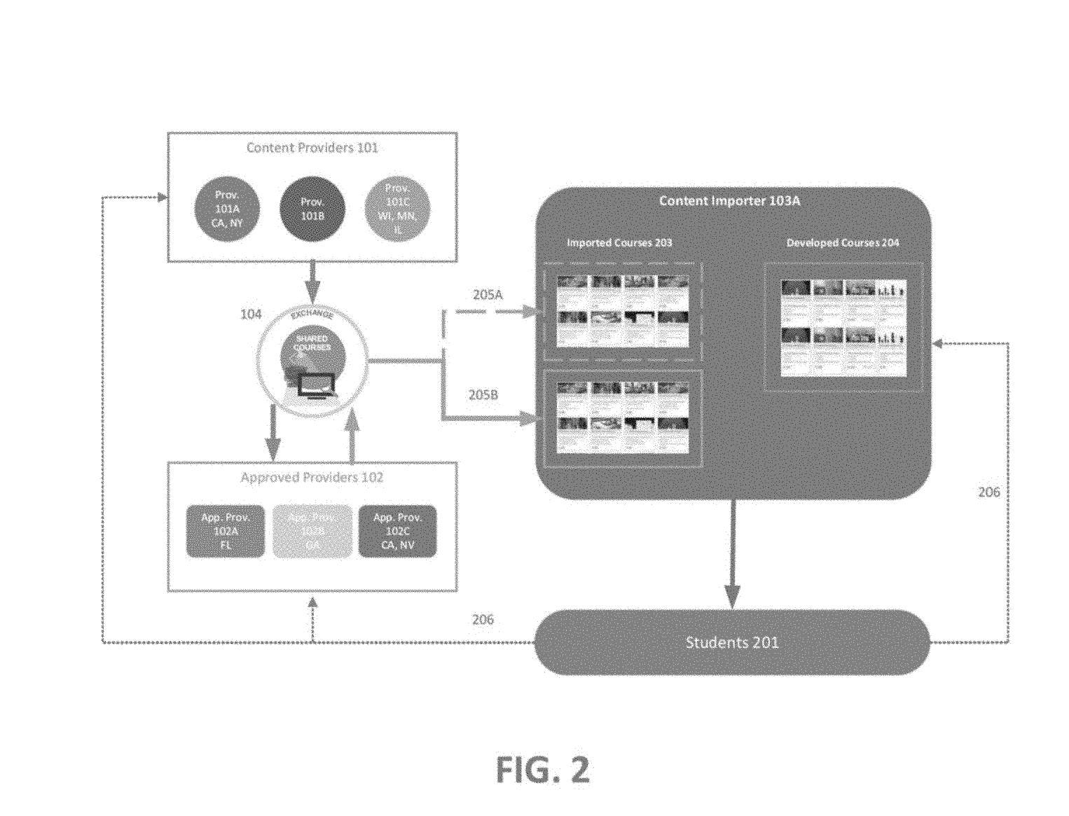

FIG. 2 illustrates courses imported by Content Importers 103A in according with an embodiment of the invention. A course can include any or all of the following: a title, course descriptions, one or more course videos, course materials (including, but not limited to, publications, slides, PDF files, and the documents), instructor information, reviews, schedules for live events or webcasts/webinars, curriculum, agendas, and other content related to the course.

In FIG. 2, Content Importer 103A offers a Course Catalog 202 comprising Imported Courses 203 and its own Developed Courses 204. Students 201 can enroll in courses from this Course Catalog 202. To supplement its own Developed Courses 204, Content Importer 203A imports relevant imported Courses 203 from Content Providers 101 using the Content Exchange 104. Course Importer 103A can manually select (205A) Imported Courses 203 from the Content Exchange 104, or courses can be imported automatically in accordance with predetermined or default rules (205B). Imported Courses 203 can be approved for credits by Content Providers 101, Approved Providers 102 or Content importer 103A. In one embodiment, Approved Providers 102 provide all the credit approvals for Imported Courses 203. In another embodiment, Imported Courses 203 can be approved for credits by either or both Content Providers 101 and Approved Providers 102. In yet another embodiment, Imported Courses 203 can be approved for credits by Content importer 103A.

Some jurisdictions may require that a credit provider or sponsor for a course maintain records of Students 201 who have taken the course for credits. Student information 206 for a Student 201 can include their professional license number, name, address, courses taken, number of credits for the courses, course reviews, attendance tracking information, course price, etc. In one embodiment, student information 206 is provided to the relevant Content Providers 101, Approved Providers 102 and/or Content Importer 103A.

The Course Importer 103A can include ecommerce for students to buy the educational content in the course catalogs. The Course Importer 103A collects monies from the students that bought the educational content and distribute the monies to Content Providers 101, Approved Providers 102, and Content importers 103. The educational content can be created to focus on a particular state, territory, or region.

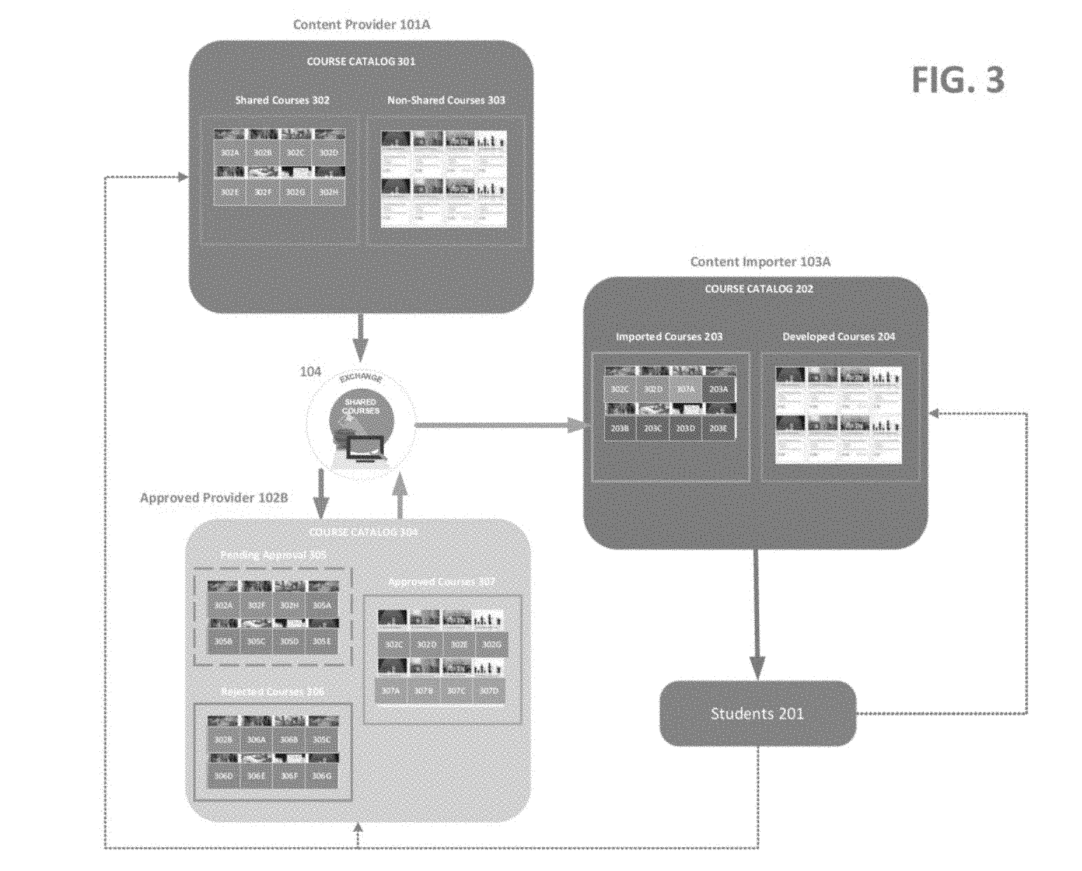

FIG. 3 illustrates the flow of courses in accordance with an embodiment of the invention. Content Provider 101A wants to share and distribute Shared Courses 302. Shared Courses 302 are routed on the Content Exchange 104, and Non-Shared Courses 303 are not placed on the Content Exchange 104. Approved Provider 102B can approve courses for credits in its approved jurisdiction(s) (in this example, GA). Courses from Content Provider 101A is routed to Approved Provider 102B for review and credit approval. The courses are first placed in Pending Approval 305. Once Approved Provider B approves the course, it is moved to Approved Courses 307 and rerouted back to the Course Exchange 102B for Content Importer 103A to import. Approved Provider 102B can also reject a course for credit, and the course can be moved to the Rejected Course 306. Another Approved Provider 102 that can approve in the same jurisdiction can still be able to approve courses that have been rejected by Approved Provider 102B.

As illustrated in FIG. 3, of eight courses (301A-H) shared by Content. Provider 101A, Approved Provider 102B has 1) approved courses 302C, 302D, 302E, and 302G, 2) rejected course 302B, and 3) yet to review courses 302A, 302F and 302H. Of the four courses from Content Provider 101A that have been approved by Approved Provider 201B, Content Importer 103A has imported courses 302C and 302D. Note that in the example Approved Provider 102B has also 1) approved courses 307A-D, 2) rejected courses 306A-G and 3) yet to review courses 305A-E. These courses are from other Content Providers 101. Likewise, Content Importer 103A has also imported 1) course 307A (which has been approved by Approved Provider 102B) and 2) courses 203A-E (which are from other Content Providers 101 and Approved Providers 102). The course catalogs 202 can include developed courses 204 that are created by the Course Importers 103. The Approved Providers 102B tracks credits that are associated with the educational content taken by the Students 201.

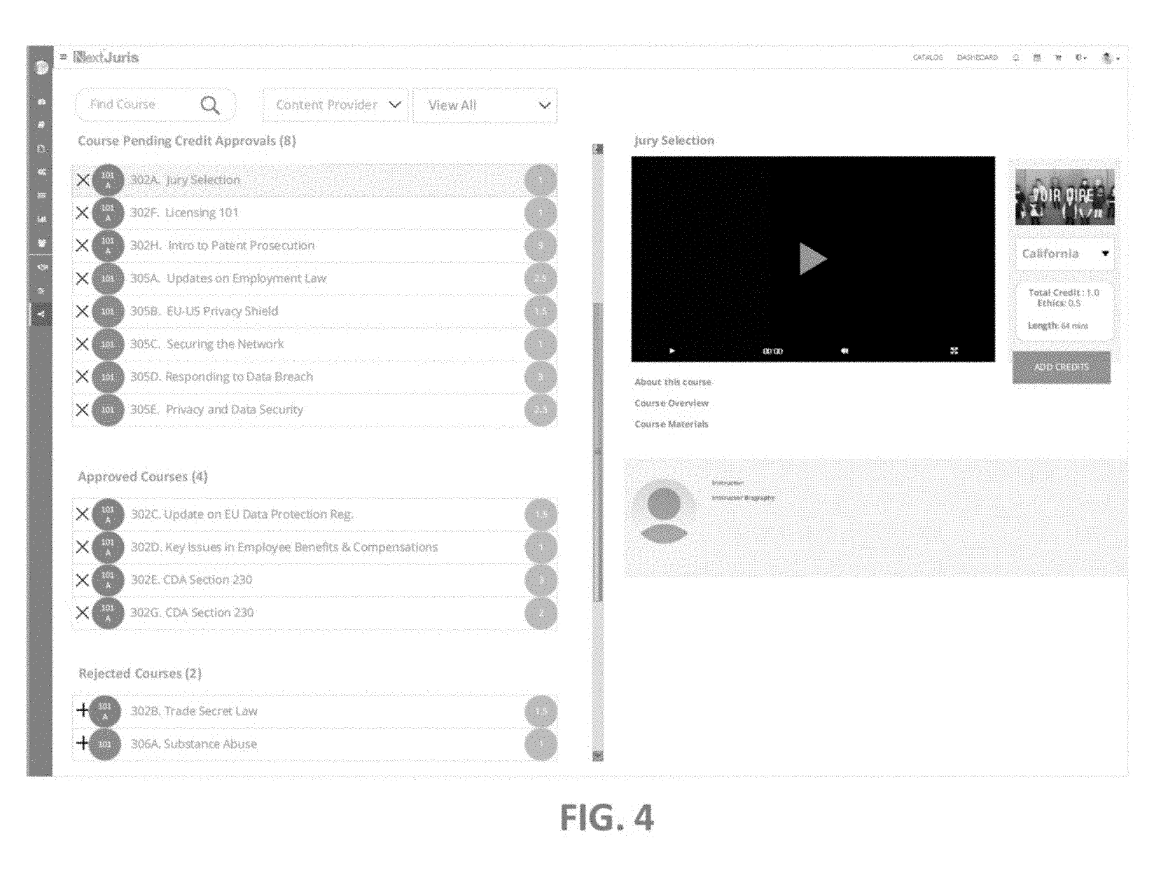

FIG. 4 shows an example of a user interface that assists the Approved Provider 102B to review and approve courses for credits in GA. Shared courses from the Course Exchange that requires credit approval in GA can appear in Course Pending Credit Approval. Approved Provider 102B can view the details of the course including the course information, course video, instructor information, and credits approved for the course in other jurisdictions. If the course streets credit requirements for GA, Approved Provider 201B can approve the course for credit in GA by adding GA credits to the course. Approved courses can be moved from pending to the Approved Course section. Approved Provider 102B can also reject courses, and they can show up in the Rejected Courses section.

Content Providers 101, Approved Providers 102 and Content importers 103 can be incentivized to share, distribute, approve courses for credits, and import courses to sell to students through a revenue sharing arrangement.

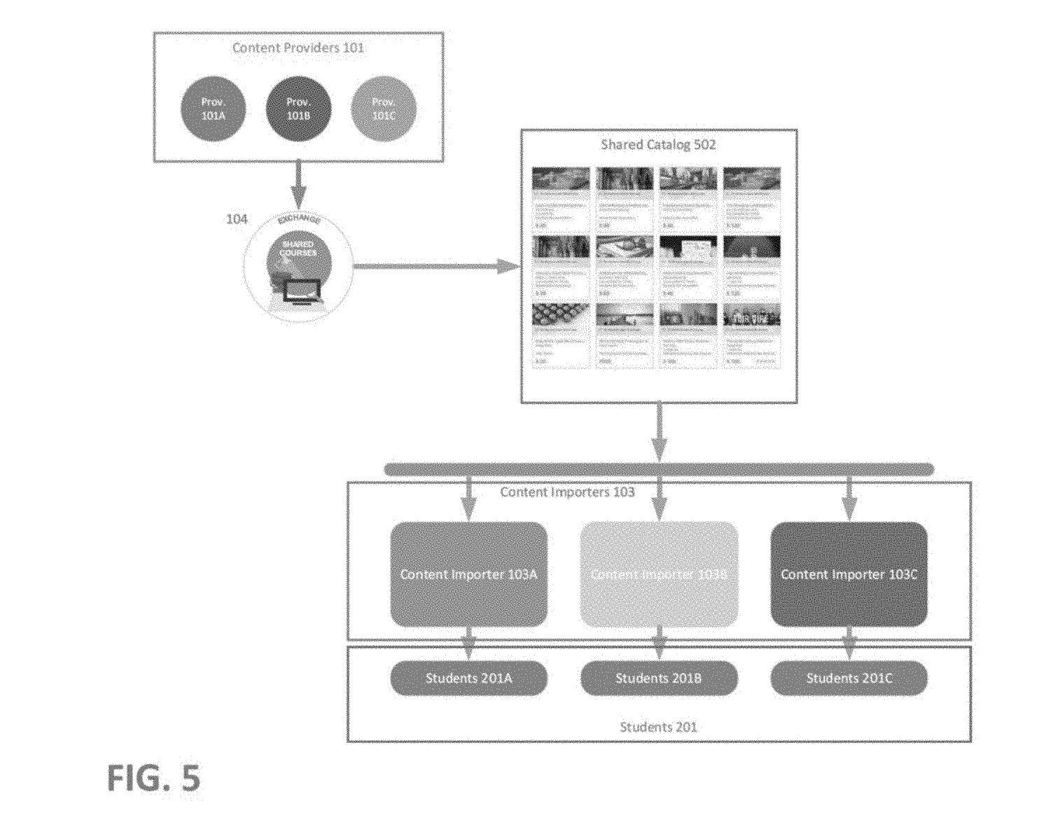

FIG. 5 shows a content exchange ecosystem that includes a content management platform with Content Providers 101 sharing and distributing courses on the Content Exchange 104. The Content Distribution Platform shown in FIGS. 1-4 discloses a course distribution platform where content importers import content from the Content Exchange 104. In FIGS. 5-7, instead of importing directly from the Content Exchange 104, the Content Exchange Ecosystem first creates a Shared Catalog 502. The Shared Catalog 502 contains courses imported from Content Providers 101 using the Content Exchange 104. The courses in the Shared Catalog 502 can be specifically curated for Content Importers 103. In one embodiment, the Shared Catalog 502 is maintained in a central depository by a program manager. Courses can be imported into the Shared Catalog 502 manually, or it can be imported automatically using a predetermined set of rules to determine which courses from Content Providers 101 should be populated into the Shared Catalog 102.

Courses from the Shared Catalog 502 are then directly and automatically placed into the catalogs of Content importers 103. Any changes, removals or additions of courses in the Shared Catalog 502 can automatically be reflected in each of the Content Importers 103 course catalogs. In this manner, Content Importers 103 do not need ally course manager to manage their course catalogs. Students 201 can take courses from the course catalogs of Content Importers 103,

In one embodiment, all courses from Shared Catalog 502 are shared and routed to each of the course catalogs of Content Importers 103. In this manner, Content importers 103A, 103B and 103C can each have the same courses from Shared Catalog 502 in each of their course catalogs.

In a second embodiment, only courses relevant to each of Content Importers 103 are taken from the Shared Catalog 502 and placed into each of the respective content importer's course catalogs. Relevant courses can be determine using predetermined rules. For example, relevance can be based on jurisdictions. To further illustrate, if Content Importer 103A only offers courses in Georgia, one such rule is to only take courses from Shared Catalog 502 with approved credits in Georgia to be placed in Content Importer 103A course catalog. Other rules for determining course relevance can be based on topics, subject matters, course types (e.g., live webcasts or on-demands), pricing, credit categories, credit subfields, content providers for the courses, and so forth.

In a third embodiment, Content Importers 103 can decide which courses from Shared Catalog 102 to import into their course catalogs. This method requires less work than importing courses directly from the Content Providers 101 since Shared Catalog 102 contains a set of courses specifically curated for sharing and distribution to Content importers 103.

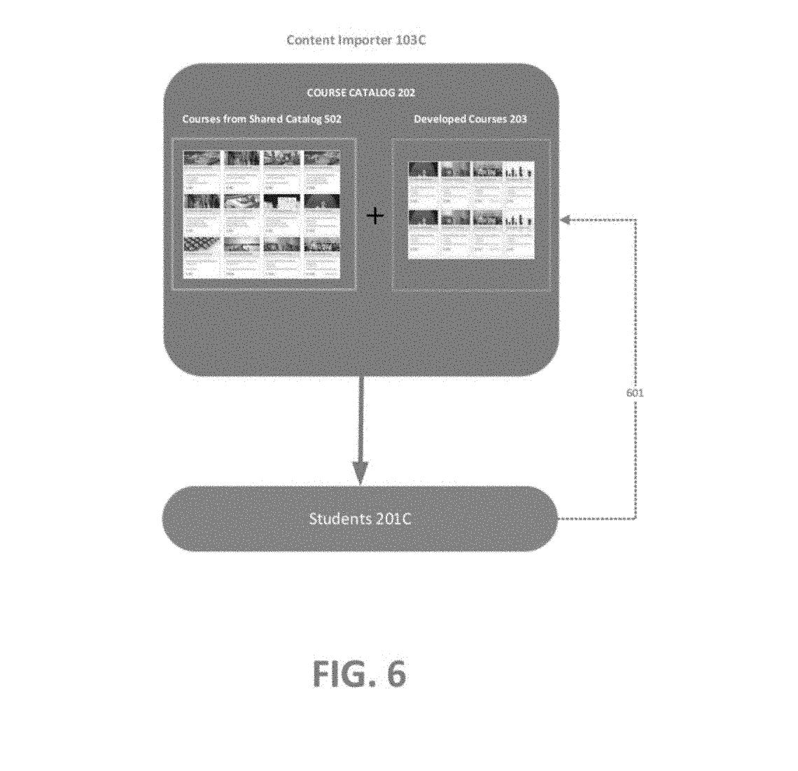

FIG. 6 shows an example of Course Catalog 202 for Content Importer 103C. Course Catalog 202 comprises courses taken from the Shared Catalog 502 and Developed Courses 203. Developed Courses 203 are courses that Content importer 103C has created (or imported or licensed in) on its own. Some Content Importers 103 may not have any Developed Courses 203, and their course catalog can rely solely on courses from Shared Catalog 502. Students 201C can take courses from Catalog 202, and student information can be sent to Content Importer 103C via line 601, as discussed in the related application, “Content Distribution Platform.”

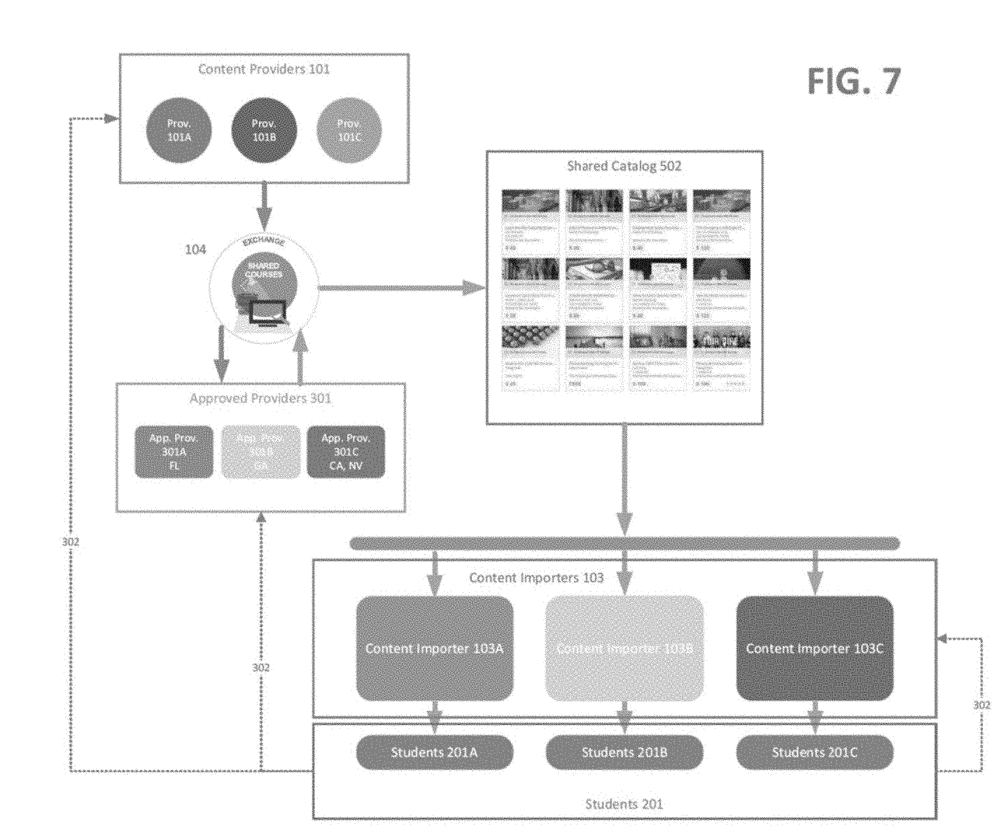

FIG. 7 shows a Content Management Platform that includes Approved Providers 301. The Approved Providers 301 approve courses from Content Providers 101 for credits in their respective jurisdictions. A detail discussion of Approved Providers 301 was discussed in detail above.

With the inclusion of the Approved Providers 301, courses offered in the Shared Catalog 502 can be approved for credits in multiple jurisdictions. Content Importers 103 can offer its students courses with credits in their respective jurisdictions.

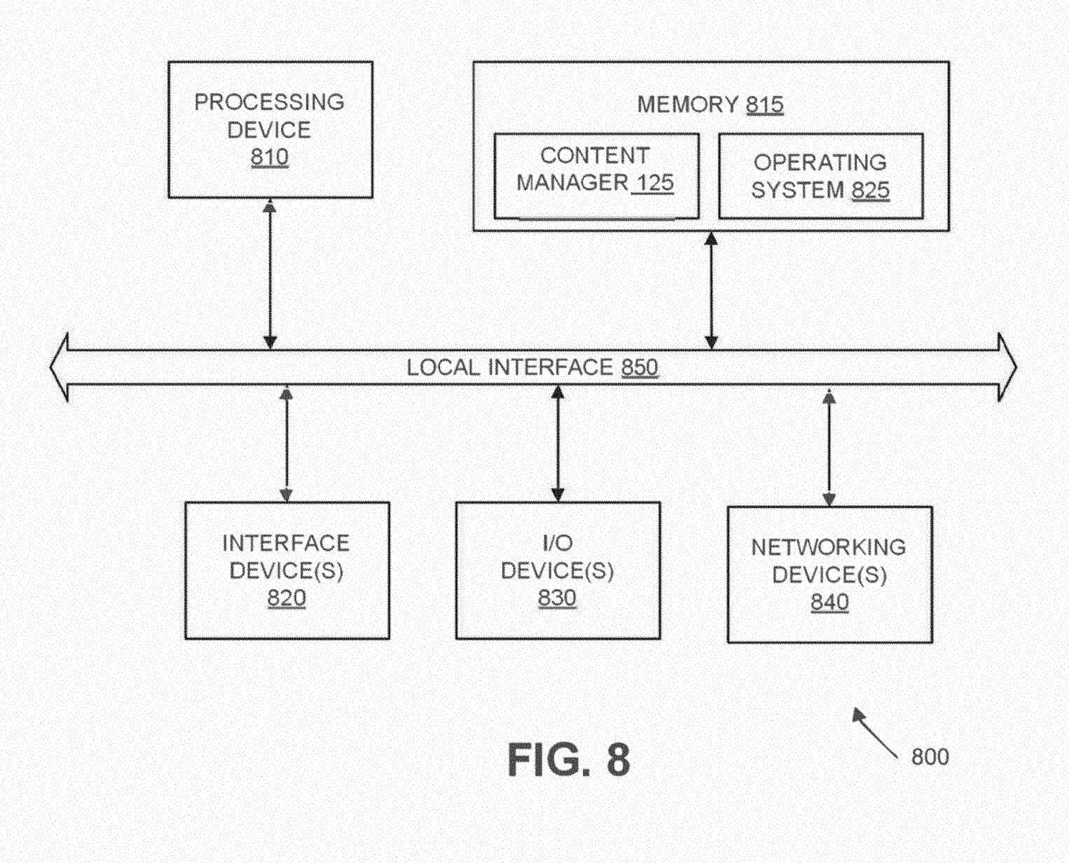

FIG. 8 is a block diagram illustrating an exemplary architecture for a generic computer 800 that is similar to the architecture of the content providers, approved providers, content importers, content exchange, and other similar devices, such as that shown in FIG. 1. As indicated in FIG. 8, the computing generic computer 800 comprises a processing device 810, data repository 815, one or more user interface devices 820, one or more I/O devices 830, and one or more networking devices 840, each of which is connected to a local interface 850. The processing device 810 can include any custom made or commercially available processor, a central processing unit (CPU) or an auxiliary processor among several processors associated with the generic computer 800, a semiconductor-based microprocessor (in the form of a microchip), or a macroprocessor. The data repository 815 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 820 comprise those components with which the user (e.g., administrator) can interact with the generic computer 800. Where the generic computer 800 comprises a server computer or similar device, these components can comprise those typically used in conjunction with a PC such as a keyboard and mouse.

The one or more I/O devices 830 comprise components used to facilitate connection of the generic computer 800 to other devices and therefore, for instance, comprise one or more serial, parallel, small system interface (SCSI), universal serial bus (USB), or IEEE 1394 (e.g., Firewire™) connection elements. The networking devices 840 comprise the various components used to transmit and/or receive data over networks (e.g., Internet, wide area network (WAN), and local area network (LAN), where provided. By way of example, the networking devices 840 include a device that can communicate both inputs and outputs, for instance, a modulator/demodulator e.g., modem), a radio frequency (RF) or infrared (IR) transceiver, a telephonic interface, a bridge, a muter, as well as a network card, etc.

The data repository 815 normally comprises various programs software and/or firmware) including an operating system (O/S) 825 and the content exchange manager 125, which has been described above. The O/S 825 controls the execution of programs, and provides scheduling, input-output control, file and data management, memory management, and communication control and related services.

The systems and methods disclosed herein can be implemented in software, hardware, or a combination thereof. In some embodiments, the system and/or method is implemented in software that is stored in a memory and that is executed by a suitable microprocessor (μP) situated in a computing device. However, the systems and methods can be embodied in any computer-readable medium for use by or in connection with an instruction execution system, apparatus, or device. Such instruction execution systems include any computer-based s system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example, but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

Note that the computer-readable medium could even be paper OF another suitable medium on which the program is printed. Using such a medium, the program can be electronically captured (using, for instance, optical scanning of the paper Or other medium), compiled, interpreted or otherwise processed in a suitable manner, and then stored in a computer memory. In addition, the scope of the certain embodiments of the present disclosure includes embodying the functionality of the preferred embodiments of the present disclosure in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions can be executed out of order from that shown or discussed, including substantially concurrently or in reverse order, depending on the functionality involved.

This description has been presented for purposes of illustration and description. It is not intended to be exhaustive or to limit the disclosure to the precise forms disclosed, Obvious modifications or variations are possible in light of the above teachings. The embodiments discussed, however, were chosen to illustrate the principles of the disclosure and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A content exchange ecosystem comprising:
a content manager that manages courses from and to various entities that participate on the content exchange ecosystem;
a content provider database that includes content catalogs of content providers on the content exchange ecosystem, wherein the content provider database provides educational content to the content manager for approval and/or importing;
an approved provider database that includes course catalogs of approved providers, wherein the approved providers receive the educational content from the content providers, and approve or reject the educational content, wherein the course manager receives the approved educational content;
a content importer database that includes course catalogs of content importers, wherein the content importers receive the educational content from the course manager and imports the educational content into course catalogs associated with the content importers.

2. The content exchange ecosystem as defined in claim 1, wherein the course manager includes ecommerce for students to buy the educational content in the course catalogs.

3. The content exchange ecosystem as defined in claim 2, wherein the course manager collects monies from the students that bought the educational content and distribute the monies to content providers, approved providers, and content importers.

4. The content exchange ecosystem as defined in claim 1, wherein the educational content is created to focus on a particular state, territory, or region.

5. The content exchange ecosystem as defined in claim 1, wherein the course catalogs include developed courses that are created by the course importers.

6. The content exchange ecosystem as defined in claim 1, wherein the approved providers issue and track credits that are associated with the education content.

7. A content exchange ecosystem comprising:
a content provider database that includes course catalogs of content providers on the content exchange ecosystem, wherein the content providers provide educational content to the course manager for approval and/or importing;
a course manager that creates a shared catalog that includes courses imported from the content provider database;
a content importer database that includes course catalogs of content importers, wherein the content porters receive the educational content imported from the shared catalog into course catalogs associated with the content importers.

8. The content exchange ecosystem as defined in claim 7, wherein the courses in the shared catalog is specifically curated for the content importers.

9. The content exchange ecosystem as defined in claim 7, wherein the course manager imports courses into the shared catalog manually, or imports automatically using a predetermined set of rules to determine which courses from the content provider database should be populated into the shared catalog.

10. The content exchange ecosystem as defined in claim 7, wherein the course manager imports at least some of the courses from the shared catalog into the course catalogs of the content importers.

11. The content exchange ecosystem as defined in claim 7, further comprising an approved provider database that includes course catalogs of approved providers, wherein the approved providers receive the educational content from the content providers, and approve or reject the educational content, wherein the course manager receives the approved educational content.
